(19) United States
(12) Patent Application Publication
(10) Pub. No.: US 2016/0052328 A1
(43) Pub. Date: Feb. 25, 2016

(54) Protective bag for storing stamps and similar products

(71) Applicant: RENATE BECK GMBH, Tiefenbach (DE)

(72) Inventor: Heinz Beck, Tiefenbach (DE)

(73) Assignee: RENATE BECK GMBH, Tiefenbach (DE)

(21) Appl. No.: 14/649,206

(22) PCT Filed: Feb. 27, 2014
(86) PCT No.: PCT/EP2014/053850

§ 371 Date: Jun. 2, 2015

(30) Foreign Application Priority Data
Mar. 18, 2013 (DE) 10 2013 004 578.9

(51) Int. Cl. B42F 5/04

(52) U.S. Cl. CPC B42F 5/04

(57) ABSTRACT

A protective pocket for stamps or similar products is provided with a contact adhesive in a sub-region of the lower film. An embodiment having a slit includes a lower film split in two. The split or unsplit lower film is provided in part with an extremely thin layer of contact adhesive. The covering, however, covers not only the contact adhesive but the entire lower film, and is thus matched in accurately fitted fashion to the outside dimensions of the strips, so that there are only slight height differences in the stacked strips. These stacks can readily be processed into protective pockets.

### FIELD OF APPLICATION

The invention relates to a protective pocket for stamps or similar products, according to the preamble of Claim 1.

### TECHNICAL BACKGROUND

Protective pockets are suitable protection for stamps that are stored in albums, on cards, or similar products.

They are made up of two stiff films (e.g. polystyrene) of equal size. These cut film pieces are as a rule approximately 4 mm larger, in length and height, than the stamp to be protected. All protective pockets are made up of a lower film and an upper film. The lower film can be transparent or colored. The upper and lower films are connected by one or two seams, depending on the version. A “seam” refers to the connection between the upper and lower film. It can be implemented, for example, by adhesive bonding or welding of the film edges (upper and lower film).

The upper film of the protective pocket is in all cases transparent. Its lower film is coated in full-area fashion, preferably with a reactivatable water-soluble adhesive.

A fundamental distinction is made between two principal groups of protective pockets:

Variant 1 has a seam only on the lower longitudinal side. Three sides of the protective pocket are thus open. The lower film is the same size as the upper film. The stamp to be stored therein is held by the clamping force of the two films, which is produced at the seam.

Variant 2: the protective pocket has a seam at the lower and at the upper longitudinal side. The lower film is slit at the center parallel to the seams.

The two protective pocket variants have approximately the same market share.

When affixing the protective pockets onto a support (e.g. album page), however, only a small area of the water-soluble adhesive is moistened, in order to minimize deformation of the support by water.

All commercially obtainable protective pockets are fabricated from so-called “strips,” which have been produced previously.

As a result of the full-area glue application (water-based), the prefabricated strips can be further processed into protective pockets in a stack. Only in this manner is it possible to efficiently produce the enormous numbers of protective pockets that are required.

Attempts to introduce self-adhesive protective pockets onto the market have so far failed due to technical problems.

Because all protective pockets are produced, as described, from strips, full-area self-adhesive protective pockets present a handling problem:

The covering (preferably made of silicone paper) on protective pockets having a full-area self-adhesive coating is difficult to detach from the lower film of the protective pocket (50μ), since the cut edges are located directly beneath one another. In addition, affixing onto a carrier requires a great deal of skill. Mistakes cannot be subsequently corrected.

Slit protective pockets, in which the lower film is provided with a full-area contact adhesive, can no longer be populated with stamps once the pockets have been affixed onto a carrier (e.g. album page). Subsequent replacement of stamps is likewise not possible.

Self-adhesive protective pockets in which a double-sided adhesive tape is used as an adhesive would meet the requirements of stamp collectors, but in this instance problems occur with production of the protective pockets.

The pre-produced strips having adhesive tape on the back side cannot be stacked, since a thickness difference occurs as a result of the applied adhesive tape.

Once five strips have been placed onto one another, this difference is so great that protective pockets can no longer be cut accurately from these strips.

The strips could thus be cut into protective pockets only individually or in a very few layers. Large quantities cannot be produced in this manner. DE 69 20 830 U, for example, describes a transparent retaining and protective sleeve for stamps or similar flat objects, in which the sleeve is attached by means of an adhesive layer. This adhesive layer, configured in the form of a strip, is provided with an accurately fitted protective covering corresponding to the dimensions of said adhesive layer, with the result that when several retaining and protective sleeves are stacked, thickness differences occur which interfere with the cutting of said retaining and protective sleeves.

DE 88 05 446 U1 furthermore describes a slip-in pocket for the reception of documents or the like on a carrier surface, in which the upper part of the foldover film is connected in part to the carrier film. With this configuration as well, the problem of cumbersome thickness differences when cutting stacks is not solved.

### PRESENTATION OF THE INVENTION

a) Technical Object

The object of the present invention is therefore to describe a protective pocket according to the preamble of Claim 1 which on the one hand ensures very easy handling and on the other hand enables efficient mass production.

b) Manner of Achieving the Object

This object is achieved according to the present invention by the features indicated in Claim 1. Advantageous embodiments are evident from the dependent claims.

The fundamental idea of the protective pocket according to the present invention is substantially that the lower film of the protective pocket, of whatever variant, is provided only in part with a contact adhesive. This can be applied in the upper or lower region of the lower film, depending on the embodiment of the respective type of pocket.

The adhesive is applied extremely thinly.

The adhesive is covered in full-area fashion, i.e. the covering used for this, preferably made of silicone paper, covers not only the applied adhesive surface, but the entire back side of the lower film of the protective pocket. It has exactly the same base outline as the protective pocket.

This protective pocket configuration yields substantial advantages:
The previously produced strips having a covering exhibit almost no height differences even when stacked. They can be cut in stacks in just as accurately fitting a manner as protective pockets with remoistenable gumming.
The manufacturing method enables the same production volumes as in the case of protective pockets having remoistenable gumming on the lower film.
The handling of self-adhesive protective pockets is substantially simplified compared with protective pockets having moistenable gumming.
Self-adhesive protective pockets cause no deformation of the support (e.g. album page), such as that which occurs on the support with remoistenable protective pockets.
The covering can be detached without difficulty from the lower film of the protective pocket.

### Processing of the Protective Pockets

The protective pocket is aligned on the support (e.g. album page) in accurately fitted fashion using the non-adhesive portion of the lower film, and then secured by pressing on the adhesive portion.

### EXEMPLIFYING EMBODIMENT

Both embodiments in accordance with the invention are described below by way of example.

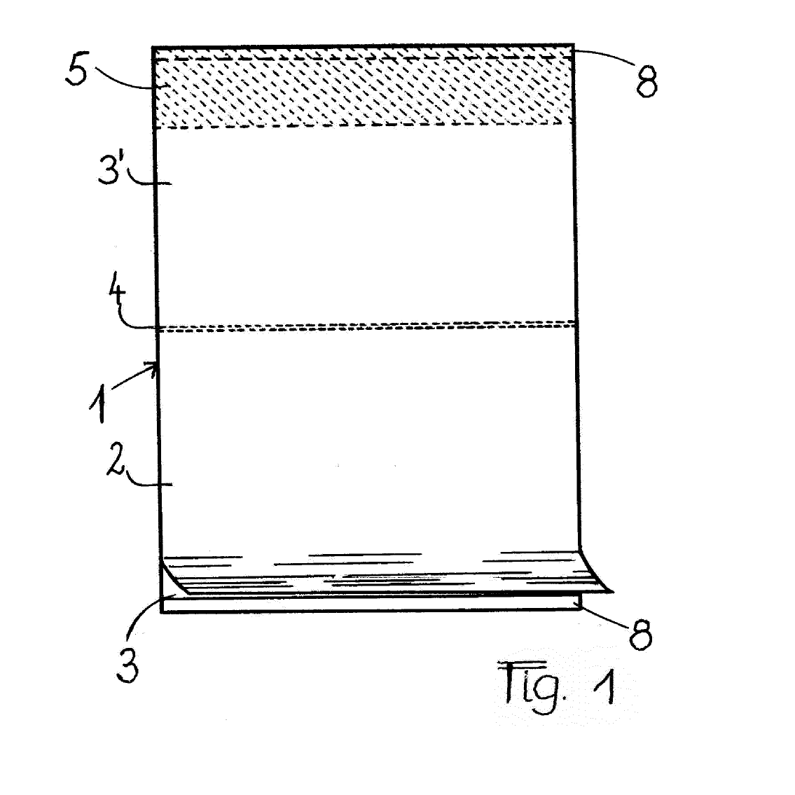

FIG. 1 is a plan view of the slit lower film of a protective pocket provided with a covering. The applied adhesive is depicted with dashed lines; it can applied onto the lower film at a different size and at different locations on the lower film.

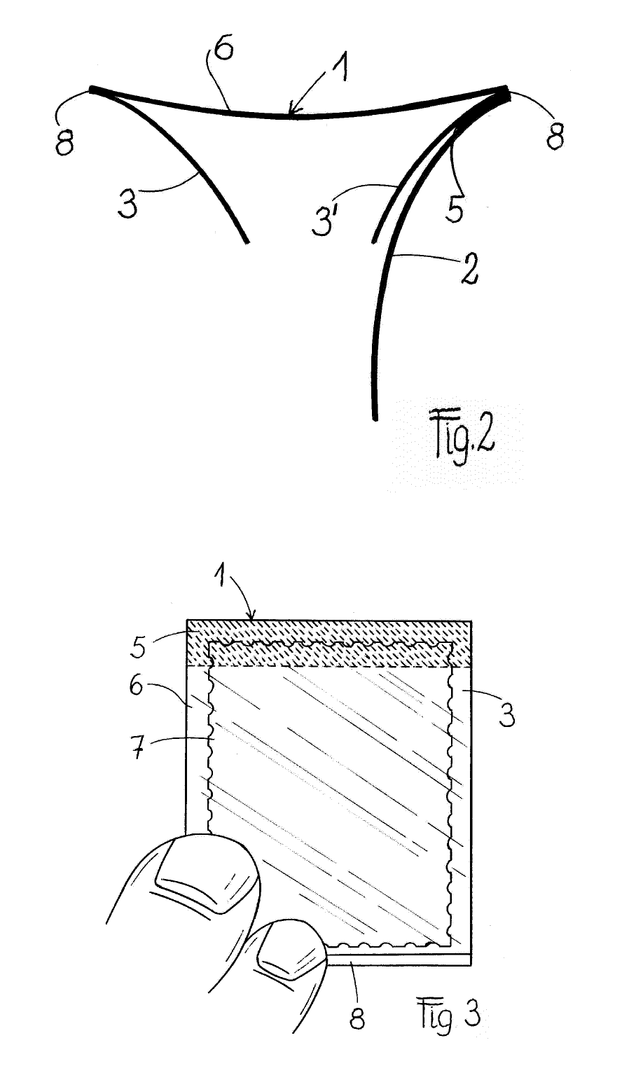

FIG. 2 is a side view of a slit protective pocket having two seams, the individual constituents of the protective pocket being shown curved for illustrative purposes.

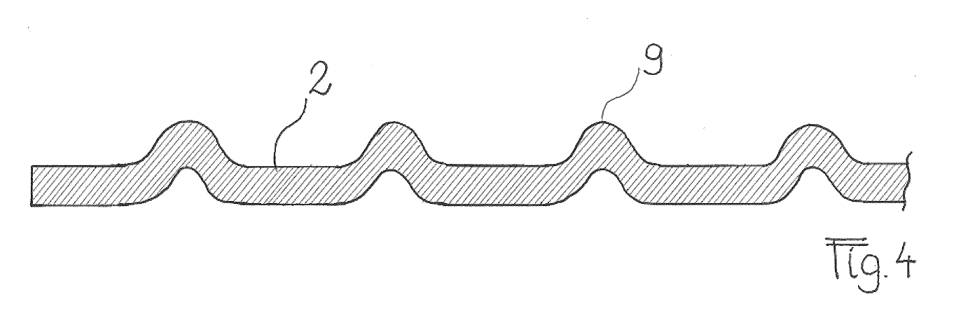

FIG. 3 is a plan view of an affixed protective pocket with a seam and an inserted stamp.

FIG. 4 is a sectioned depiction of a variant of the covering (2) that exhibits slight deformations.

FIG. 1 of the drawings depicts lower film 3; 3′ of a protective pocket 1 according to the present invention having a covering 2. Lower film 3; 3′, which rests on the support (e.g. album page) when attached, is provided with a slit 4. Slit 4 splits lower film 2 [sic] of protective pocket 1 into two halves parallel to seams 8.

Protective pocket 1 is provided in the upper region with a strip, depicted with dashed lines, of contact adhesive 5. This contact adhesive 5 secures covering 2, which corresponds exactly to the size of protective pocket 1 and thus completely covers lower film 3; 3′. To illustrate the fact that covering 2 rests loosely on lower film 3; 3′ of protective pocket 1 in the lower region of the drawing, its lower edge is shown slightly raised.

In the example shown, contact adhesive 5 is depicted in the form of a strip. The adhesive layer can, however, also be applied onto lower film 3; 3′ over a larger area, as a spot, or in another conformation.

The side view of a protective pocket according to FIG. 2 illustrates how the individual parts of protective pocket 1 according to the present invention are fitted together. The depiction therefore shows protective pocket 1 in the spread-apart state, the individual parts being shown in curved fashion for better illustration.

Protective pocket 1 comprises an upper film 6 whose length corresponds exactly to the length of covering 2 and to the total length of lower film 3; 3′ or of the two parts of lower film 3; 3′.

As depicted in FIG. 1, covering 2 is easily detachable from protective pocket 1.

FIG. 3 is a plan view of a protective pocket 1 having only one seam 8. It is evident that the outer edge of protective pocket 1 projects beyond the edge of the inserted stamp 7.

FIG. 4 depicts a variant of covering 2. Here covering 2 exhibits slight deformations. In the example depicted, these are embodied in the form of corrugations arranged at regular intervals. Alternatively thereto, these deformations can also be embodied in another manner, for example in the form of spot-shaped elevations. The deformations can also be applied on both sides.

Protective pockets 1 according to the present invention are cut in a stack from the previously produced strips, made up of upper film 6, lower film 3; 3′, applied adhesive 5, and covering 2. Stamps 7 (or similar products) can be inserted by the collector into protective pocket 1 before or after a protective pocket 1 is affixed onto a support (e.g. album page). It is usual to insert stamp 7 (or similar products) only after protective pocket 1 has been affixed.

The affixing of a protective pocket 1 onto a support (e.g. album page), and detachment of covering 2 from lower film 3; 3′, take place as follows:
Pull covering 2 off lower film 3; 3′.
Lift protective pocket 1 slightly with a finger in the region of the adhesion point, and in that state align it on the support (e.g. album page).
After alignment, secure protective pocket 1 by pressing gently onto the support (e.g. album page).

In summary, it is evident that protective pocket 1 according to the present invention, having a thin contact adhesive 5 on a portion of the surface of lower film 3; 3′ and having the full-area covering 2, affords substantial advantages. For example, even stacked strips coated with contact adhesive can be further processed in large numbers into protective pockets 1.

Advantages for the User:

7
No accessories such a moistening sponge or damp cloth are needed in order to moisten protective pocket 1.
No deformation of the support (e.g. album page or the like) as a result of moistened protective pockets 1.
Covering 2 can be detached without difficulty from lower film 3; 3′ of protective pocket 1, since only a portion of the surface of lower film 3; 3′ is coated with contact adhesive 5.
Protective pocket 1 can be aligned in accurately fitted fashion on a support (e.g. album page) and affixed.

It is self-evident that the fundamental idea according to the present invention can also be utilized for all other embodiments of a protective pocket 1. This also applies to protective pockets 1 that are suitable for a different purpose.

As is apparent from the preceding description, protective pocket 1 for stamps or similar products is provided with a contact adhesive 5 in a sub-region of lower film 3; 3′. An embodiment having a slit 4 results in a lower film 3; 3′ split in two. The split or unsplit lower film 3; 3′ is provided in part with an extremely thin layer of contact adhesive 5. Covering 2, however, covers not only contact adhesive 5 but the entire lower film 3; 3′, and is thus matched in accurately fitted fashion to the outside dimensions of the strips, so that there are only slight height differences in the stacked strips. These stacks can readily be processed into protective pockets 1.

The application of adhesive only onto a part of lower film 3; 3′, and the conformation of covering 2, also enable the stamp collector to easily remove this covering 2 from protective pocket 1. When a protective pocket 1 is affixed onto a support (e.g. album page), an easy and accurately fitted result is guaranteed. A further great advantage: the supports (e.g. album page) populated with self-adhesive protective pockets 1 do not become distorted; they remain flat.

### LIST OF REFERENCE CHARACTERS

1 Protective pocket
2 Covering
3; 3′ Lower film
4 Slit
5 Contact adhesive
6 Upper film
7 Stamp
8 Seam
9 Deformation

The invention claimed is:

1. A protective pocket (1) for stamps or similar products, comprising:
a lower film (3; 3′);
an adhesive (5) provided on the lower film; and
a detachable covering (2) protecting the adhesive, the detachable covering being configured for affixing onto collection albums or other support materials,
wherein the adhesive (5) is configured in an extremely thin layer, and
wherein the detachable covering (2) is larger than an area of the adhesive (5) and corresponds in accurately fitting fashion to an outside dimensions of the protective pocket (1).

2. The protective pocket (1) for stamps or similar products according to claim 1, wherein the adhesive is comprises a contact adhesive (5).

3. The protective pocket (1) for stamps or similar products according to claim 2, wherein the contact adhesive (5) is applied only onto a portion of the lower film (3; 3′) of the protective pocket (1).

4. The protective pocket (1) for stamps or similar products according to claim 2, wherein, if the lower film is a two-part lower film (3; 3′) configured as two halves separated by a slit (4), the contact adhesive (5) is applied onto only one of the two lower-film halves (3; 3′).

5. The protective pocket (1) for stamps or similar products according to claim 1, wherein the detachable covering (2) includes deformations (9) on its surface.

6. The protective pocket (1) for stamps or similar products according to claim 5, wherein the deformations are embodied as corrugation- or spot-shaped elevations.
